(19) United States
(12) Patent Application Publication
(10) Pub. No.: US 2025/0232330 A1
(43) Pub. Date: Jul. 17, 2025

(54) Sharing Ad and Linked Use Content Accounting (SALUCA)

(71) Applicant: Cristian Ruvalcaba, La Mesa, CA (US)

(72) Inventor: Cristian Ruvalcaba, La Mesa, CA (US)

(21) Appl. No.: 18/414,669

(22) Filed: Jan. 17, 2024

(51) Int. Cl. G06Q 30/0242; G06Q 30/0241

(52) U.S. Cl. CPC G06Q 30/0242; G06Q 30/0247

(57) ABSTRACT

A process for establishing more accurate metrics and enabling of ad revenue sharing between content creators. Some content creators created references content and with fair use, will sometimes include segments of the original content or also include links to the original content as part of the metadata associated to a given material. The consumer of the created content sees content created by their desired creator along with reference content by that creator. This process establishes a method for the content creators for both the desired video and its embedded content to receive ad revenue from advertisers while also ensuring that the referenced material also receives appropriate increase in consumption metrics, for example ‘views.’

### FIELD OF INVENTION

The present invention is directed towards the sharing of ad revenue and more accurate consumption metrics of user generated content and other multi-media content. In particular, for video and audio based content that makes reference to and incorporates multi-media content developed by other creators, along with the relevant advertisers for all creators involved in or referenced by the content in question.

### BACKGROUND OF THE INVENTION

For over a century, media, tactical, audio or visual, has been used as a method of communication and entertainment. As part of the multi-media distribution ecosystem, along with broadcast standards and regulations established with governmental oversight, the use of advertisement revenue as a means of media production and distribution cost recovery for the multi-media artifact while the advertising firm and advertised company and related product benefited from audience awareness of the product through means of product placement or of separately fully developed segments, colloquially referred to as ‘commercials’ or ‘ads.’

As the methods and technologies for media distribution evolved, ads evolved alongside them to craft the most convincing messaging intended to convert a media consumer into a customer of the advertising vendor. These ads were traditionally inserted into the media's outgoing communication channel, or added as a full page or partial page image in print media. Eventually advertising overlay on top of the media consumed by the audience became available.

The approach to media production has followed a similar evolution to the methods and technologies, most recently with more independent production and user generated content. Radio and television ads now have their digital equivalents with enhanced functionality, including click-through access to visit the advertised product or service directly. Print media ads also have their digital equivalent. Technology has advanced to a point where these ads no longer need to be shared with every consumer, and may instead be used with consumer most likely to follow through on a purchase. Some advertisers will also collaborate with content creators to have an influencer-centric paid advertisement campaign.

Media creators may sometimes choose whether or not to have advertisement associated with their media, others may not have an option, depending on the distribution medium. These may take the form of inserted media packages in the timelines of the audio or video media. Some creators may record and include into their own content, self contained packages touting certain products or services, working with those vendors in a form of paid advertising. Some creators may reference third party content and play the content through fair-use, providing an original opinion or take on the other party's media. That same creator may benefit from advertising revenue that comes from agreements with vendors for paid advertising packages, ads inserted into the media timeline, or with embedded image based advertising on the webpage on which the consumer partakes in the streaming media. In this instance, the creator of the referenced material yields no direct benefit from their material being used for content creation by others.

The amount of times that a content creator's media has been used for content creation along with the number of times that this media may have been consumed through those other means may not be concretely known. The amount of collaboration that could successfully be measured against all parties involved may not be concretely known. The prevalence of viral trends and consumable content has further expanded who may be considered a content creator to almost anyone with an internet enabled mobile device.

### SUMMARY OF THE INVENTION

The present invention uses a process to more accurately measure consumption metrics for multi-media artifacts and provides a revenue sharing model for advertising presented during the consumption of media artifacts from multiple parties as part of a single media ‘package.’

While configuring the settings for an uploaded media artifact, the creator would be able to add ‘embedded,’ or referenced, media links as well as the time stamps at which to exit the current media artifact to present the referenced material, at what time stamp to begin the referenced material, at what time stamp to exit the referenced material and at what time stamp to return to the originating video stream. The user may also be presented with an option to choose when a ‘transition ad’ would be amenable, from the originating video to the embedded clip, during the return transition, both, or none. It may still be at the discretion of the distribution channel as to which transition would be used if both options are selected.

The distribution channel would have at its discretion items to permit for configuration, including how many media artifacts can be embedded to a single media artifact, the minimum length of original material as compared to referenced material. Whether or not to offer advertising configuration options to the content creator, if a subset or all of the embedded artifacts would be used as transition triggering events for ad insertion.

The process would use tracking elements used for session or consumption tracking to ensure consumption count metrics are provided to the referenced material owners as part of their own metrics with an added metric referencing this process of reference. Advertisers would receive metric information when using this process, enabling a clear distinction between ads shared by individual creators on a self contained package, and those that leverage this process, along with the relevant conversation percentages. Content creators may benefit from the advertising vendors that have advertising contracts with more established media creators, while the more established media creators, for example artists, musicians and independent press, to expand their direct reach and thus their own ad revenue.

The process would also provide content creators with creative ways to use otherwise ‘hidden’ media artifacts to add additional content, creating an easter-egg hunt gamified interaction with their audience, for example, providing a keyword to submit to a loyalty program for points, or to run a contest. This level of engagement would in turn create more engagement and the potential for more consumption of media artifacts and thus, more ad revenue.

### BRIEF DESCRIPTION OF DRAWINGS

FIG. 1 is the sequence of media artifacts following this process for one instance of referenced, or embedded, media with ads inserted before and after the embedded media.

FIG. 2 is the sequence of media artifacts following this process for one instance of referenced, or embedded, media with ads inserted only after the embedded media.

FIG. 3 is the sequence of media artifacts following this process for one instance of referenced, or embedded, media with ads inserted just before the embedded media.

FIG. 4 is the sequence of media artifacts following this process for one instance of referenced, or embedded, media with no ads inserted either before or after the embedded media.

FIG. 5 is a sample mock-up of configuration options a content creator may have when referencing other media for embedding.

FIG. 6 is the detailed flow chart for an instance of media artifact reference in an audio or video stream.

### DETAILED DESCRIPTION OF THE INVENTION

Referring now to the drawings.

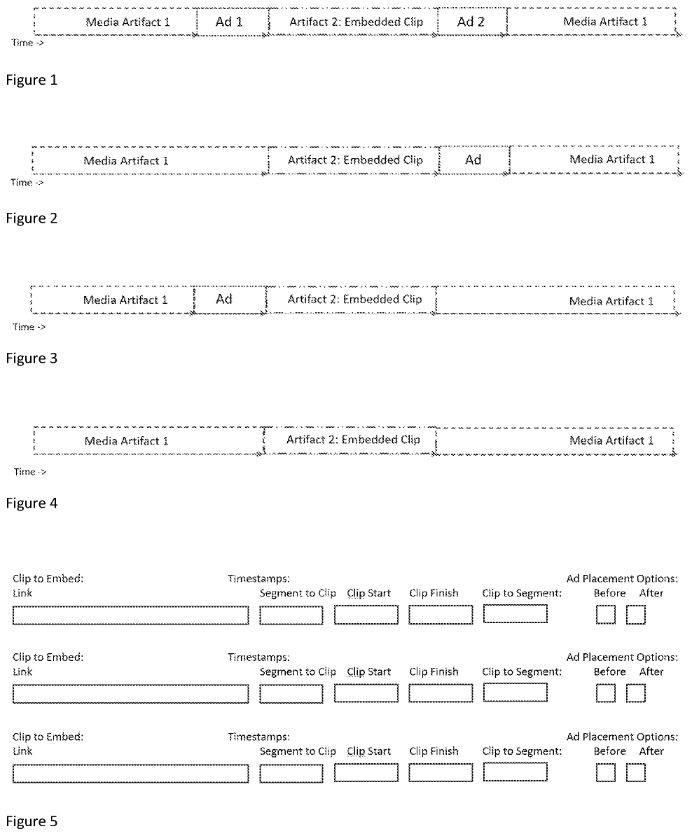

FIG. 1 depicts the media artifact consumption timeline as perceived by the consumer when this process is technically implemented and ads are included in both transitions between media artifacts.

FIG. 2 depicts the media artifact consumption timeline as perceived by the consumer when this process is technically implemented and ads are included in transition between the embedded media artifact back to the referring media artifact.

FIG. 3 depicts the media artifact consumption timeline as perceived by the consumer when this process is technically implemented and ads are included in transition between current media artifact stream to the embedded reference material.

FIG. 4 depicts the media artifact consumption timeline as perceived by the consumer when this process is technically implemented and no ads are included.

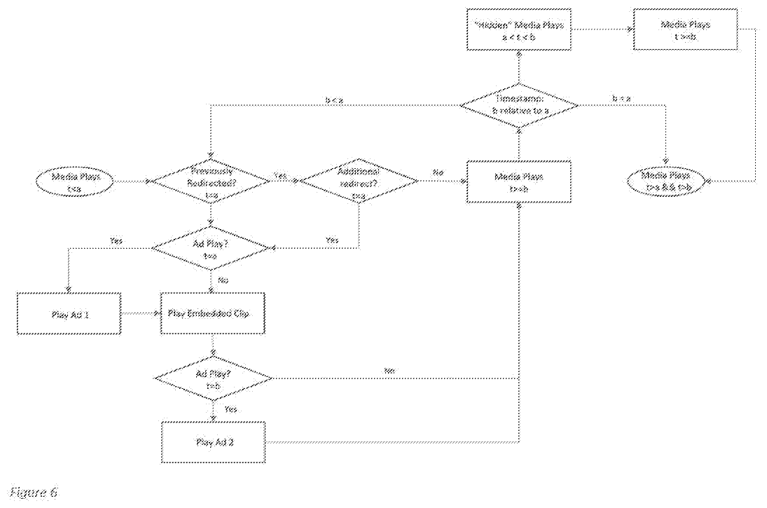

FIG. 5 depicts a mock-up of settings that a content creator may be presented with in order to embed reference media artifacts. The details include a link to the referenced source material, the timestamp on the uploaded artifact at which to break away to the referenced material, the timestamp on the uploaded artifact at which point to return from the referenced material, the timestamp at which to begin the reference material and a timestamp at which to break away from the referenced material. The timestamps on the uploaded material requires a breakaway timestamp, the return timestamp may be optional to add specific functionality. The mock-up also includes a configuration option for ad placement during transitions, another optional item of functionality.

FIG. 6 depicts the process flow for a single instance of the ad and metric sharing. The process begins with the media current timestamp of ‘t,’ has reference timestamps of a, referring to the breakaway from uploaded artifact to referenced material, and b, the breakaway from referenced material to uploaded artifact. Once timestamp t reaches the value of a, a conditional decision is made to determine whether or not an ad is to be played during this transition. If an ad is played, the embedded clip is started immediately after the ad. If no ad is played, the embedded clip is played once the decision to not play an ad is performed. Once the reference material has been fully consumed, a decision is made as to whether or not to play an ad when returning to the original video. If an ad is played, the media consumer is returned to the uploaded material once the ad is completed at timestamp b. If no ad is played, the consumer is returned to the uploaded material at timestamp b directly.

At this point, depending on the relative values of a and b, the entire process may initiate again if the hosting platform allows for allowing ad loops and b is less than a, or will skip the ads on this transition for this session moving forward. If a is less than b, a segment of ‘hidden media’ is established allowing for content creators to embed material within their own stream that would otherwise not be seen by a casual consumer. Consumers would be able to review this material by leveraging functionality of media players that allow for adjusting the media stream's current playback timestamp. The default configuration would be where timestamps a and b are equal and the consumer is returned to the moment they were referred to another reference material.

### Particular Applications to Computer Devices

The methods and apparatus applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

A desired embodiment according to this invention also works within many types of networks, applying to information system networks of any kind, including but not limited to traditional infrastructure networks, hosted infrastructure and application environments, media hosting and streaming platforms and blockchain technologies.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

1. A process for establishing more accurate metrics and enabling of ad revenue sharing between content creators.

2. The process of claim 1, wherein said process more accurately measures consumption metrics for uploaded multi-media artifacts and provides a revenue sharing model for advertising presented during the consumption of media artifacts from multiple creators as part of a single media package.

3. The process of claim 2, wherein while configuring the settings for said uploaded media artifacts, said creator would be able to add ‘embedded,’ or referenced, media links as well as the time stamps at which to exit the current media artifact to present the referenced material, at what time stamp to begin the referenced material, at what time stamp to exit the referenced material and at what time stamp to return to the originating media artifact.

4. The process of claim 3, wherein said process begins with the uploaded media artifact current timestamp of ‘t,’ has reference timestamps of a, referring to the breakaway from uploaded artifact to referenced material, and b, the breakaway from referenced material to uploaded artifact.
